(19) United States
(12) Patent Application Publication
(10) Pub. No.: US 2016/0155156 A1
(43) Pub. Date: Jun. 2, 2016

(54) Systems and Methods for Presenting Real Time Customized Data to a User

(71) Applicant: American Express Travel Related Services Company, Inc., New York, NY (US)

(72) Inventors: Sudhakar Gopal, Scottsdale, AZ (US); Kishore R. Narayan, Phoenix, AZ (US); Siva R. Chilukuri, Scottsdale, AZ (US); Andrew E. Silverman, New York, NY (US); Danielle G. Matthews, New York, NY (US); Henry H. Yuan, New York, NY (US)

(73) Assignee: American Express Travel Related Services Company, Inc., New York, NY (US)

(21) Appl. No.: 15/018,623

(22) Filed: Feb. 8, 2016

Related U.S. Application Data
(63) Continuation-in-part of application No. 13/794,374, filed on Mar. 11, 2013.
(60) Provisional application No. 61/646,778, filed on May 14, 2012.
(60) Provisional application No. 61/610,981, filed on Mar. 14, 2012.
(60) Provisional application No. 61/610,983, filed on Mar. 14, 2012.
(60) Provisional application No. 61/610,461, filed on Mar. 13, 2012.

(51) Int. Cl. G06Q 30/02

(52) U.S. Cl. CPC G06Q 30/0269

(57) ABSTRACT

The systems and methods described herein may be used to recommend and provide real time information consumers, in accordance with various embodiments. The systems and methods may comprise operations performed by an information kiosk in electrical communication with other components. The operations may include retrieving, transaction history data associated with a user profile, analyzing the transaction history data, determining a consumer relevance value for items based on the transaction history data, monitoring real time information about a consumer, analyzing the real time information, adjusting the consumer relevance value based on and in response to the analyzing the real time information, receiving identifier information from the consumer, identifying a user profile associated with the identifier information, retrieving a merchant offer from an offer database based on the consumer relevance value associated with the user profile, and/or transmitting a merchant offer onto the display comprised in the information kiosk.

### CROSS REFERENCE TO RELATED APPLICATIONS

This application is a Continuation-In-Part of, and claims priority to and the benefit of, U.S. patent application Ser. No. 13/794,374 filed on Mar. 11, 2013 and entitled “SYSTEMS AND METHODS FOR TAILORED MARKETING.” The '374 application claims priority to and the benefit of U.S. Provisional Patent Application Ser. No. 61/646,778 filed May 14, 2012 entitled “SYSTEMS AND METHODS FOR TAILORED MARKETING BASED ON FILTERING.” The '374 application further claims priority to, and the benefit of, U.S. Provisional Patent Application Ser. No. 61/610,981 filed Mar. 14, 2012 entitled “GENERATING A CUSTOMER REVIEW USING CUSTOMIZED TAGS.” The '374 application further claims priority to, and the benefit of, U.S. Provisional Patent Application Ser. No. 61/610,983 filed Mar. 14, 2012 entitled “TRANSACTION REWARDS LIST.” The '374 application further claims priority to, and the benefit of, U.S. Provisional Patent Application Ser. No. 61/610,461 filed Mar. 13, 2012 entitled “GENERATING MERCHANT RECOMMENDATIONS FOR CONSUMERS.” All of the aforementioned applications are incorporated by reference in their entirety for all purposes.

### FIELD

The present disclosure generally relates to an information kiosk for providing real time information to a consumer.

### BACKGROUND

With the ability to tailor marketing to specific consumers, and the highly mobile nature of today's society, marketing techniques should be able to provide consumers with real time, customized data in a convenient fashion.

### SUMMARY OF THE INVENTION

In various embodiments, a system, method, and article of manufacture (collectively, “the system”) are disclosed to provide consumers or users with real time, customized information. The system may be configured to perform operations including retrieving, by an information kiosk and via a transaction database, transaction history data associated with a user profile. The information kiosk may comprise a processor, a tangible non-transitory memory, a network interface, a display, and an identity reader. The system may be capable of analyzing, by the information kiosk and via a collaborative scoring algorithm comprised in a scoring system, the transaction history data. The system may be capable of determining, by the information kiosk and via the scoring system, a consumer relevance value for one or more merchant offer based on analyzing the transaction history data.

In various embodiments, the system may be capable of monitoring, by the information kiosk and via a real time analysis system, real time information about a consumer. The system may further be capable of analyzing, by the information kiosk and via the real time analysis system, the real time information about the consumer. The system may further be capable of adjusting, by the information kiosk and via the scoring system and/or the real time analysis system, the consumer relevance value, based on and in response to, the analyzing the real time information about the consumer.

In various embodiments, the system may be capable of receiving, by the information kiosk and via the identity reader, identifier information from the consumer. The system may further be capable of identifying, by the information kiosk and via an identification database, a user profile associated with the identifier information. The system may further be capable of retrieving, by the information kiosk, one or more merchant offer from an offer database based on the consumer relevance value associated with the user profile. The system may further be capable of transmitting, by the information kiosk and via the display, one or more merchant offer onto the display comprised in the information kiosk.

In various embodiments, the collaborative scoring algorithm may receive as an input transaction history data associated with a consumer, a demographic of the consumer, a user profile, a type of transaction account, a transaction account associated with the consumer, a period of time that the consumer has held a transaction account, a size of wallet, a share of wallet, consumer feedback, information associated with an item usage, and/or information associated with a product usage.

In various embodiments, the system may further be capable of generating, by the information kiosk and based on a plurality of consumer relevance values, a ranked list of merchant offers comprising a highest range of consumer relevance values. In various embodiments, the system may further be capable of authenticating, by the information kiosk via the identity reader, the user presenting the identifier information to the information kiosk.

In various embodiments, the identifier information may be a digital token, transaction history data, and/or a user device. In various embodiments, the identity reader may be a payment reader, a near field communication device, and/or a biometric scanner. In various embodiments, the payment reader may be a card reader.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1A shows an exemplary system diagram, in accordance with various embodiments.

FIG. 1B shows an exemplary illustration of an information kiosk, in accordance with various embodiments.

FIG. 2 shows a screenshot depicting an interface displaying offers and benefits to the consumer or user, in accordance with various embodiments.

FIG. 3 shows a screenshot depicting an interface displaying types of benefits to the consumer or user, in accordance with various embodiments.

FIG. 4 shows a screenshot depicting an interface displaying various items based on location to the consumer or user, in accordance with various embodiments.

FIG. 5 shows a flowchart depicting an exemplary process for scoring items, such as merchant offers, in accordance with various embodiments.

FIG. 6 shows a flowchart depicting an exemplary process for adjusting a consumer relevance value, in accordance with various embodiments.

FIG. 7 shows a flow chart depicting an exemplary process for presenting a consumer or user with items, such as merchant offers, in accordance with various embodiments.

### DETAILED DESCRIPTION

The present disclosure generally relates to filtering, and more particularly, to tailored marketing to consumers based on filtering. The detailed description of various embodiments herein makes reference to the accompanying drawings, which show the exemplary embodiments by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The phrases consumer, consumer, user, account holder, account affiliate, cardmember or the like may be used interchangeably and shall include any person, group, entity, business, organization, business, software, hardware, machine and/or combination of these, and may, in various embodiments, be associated with a transaction account, buy merchant offerings offered by one or more merchants using the account and/or be legally designated for performing transactions on the account, regardless of whether a physical card is associated with the account. For example, a consumer or account affiliate may include a transaction account owner, a transaction account user, an account affiliate, a child account user, a subsidiary account user, a beneficiary of an account, a custodian of an account, and/or any other person or entity affiliated or associated with a transaction account.

A bank may be part of the systems described herein, and the bank may, in various embodiments, represent other types of card issuing institutions, such as credit card companies, card sponsoring companies, or third party issuers under contract with financial institutions. It is further noted that other participants may be involved in some phases of a transaction, such as an intermediary settlement institution.

Phrases and terms similar to “business,” “merchant,” “service establishment,” or “SE” may be used interchangeably with each other and shall mean any person, entity, distributor system, software and/or hardware that is a provider, broker and/or any other entity in the distribution chain of goods or services. For example, a merchant may be a grocery store, a retail store, a restaurant, a travel agency, a service provider, an on-line merchant and/or the like. In various embodiments, a merchant may request payment for goods and/or services sold to a consumer or consumer who holds an account with a transaction account issuer.

Terms such as “transmit,” “communicate” and/or “deliver” may include sending electronic data from one system component to another over a network connection. Additionally, as used herein, “data” may include information such as commands, queries, files, data for storage, and/or the like in digital or any other form.

As used herein, “transmit” may include sending electronic data from one system component to another over a network connection. Additionally, as used herein, “data” may include encompassing information such as commands, queries, files, data for storage, and the like in digital or any other form.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device such as, for example, an information kiosk, a workstation, and/or the like, online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

A “transaction” may include one or more approved authorizations. Moreover, the phrase “transaction data” may comprise data associated with one or more transactions. In various embodiments, an authorization may be approved by a payment processor in response to a transaction request, which may be initiated by a consumer and/or a merchant.

Phrases and terms similar to “item” may include any good, service, information, experience, data, content, access, rental, lease, contribution, account, credit, debit, benefit, right, reward, points, coupons, credits, monetary equivalent, anything of value, something of minimal or no value, monetary value, offer, merchant, type of merchant, demographic data, preference data, consumer profile data, consumer profile, type of transaction account, transaction account, period of time (e.g., a period of time a consumer has been a consumer of a transaction account issuer), size of wallet, share of wallet, information, and/or the like. Further, in various embodiments, an item may comprise an input to and/or an output of a collaborative filtering or recommendation algorithm.

An “offer” may comprise any data and/or information. An offer may comprise one or more items. In addition, an offer may comprise data associated with one or more items. An offer may further comprise one or more characteristics or metadata. The characteristics or metadata associated with an offer may describe one or more attributes associated with the offer. Further, in various embodiments, an offer may comprise an offer to purchase good or service offered for sale by a merchant or SE. Similarly, in various embodiments, an offer may be associated with a merchant or SE.

As used herein, “match” or “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

The consumer may be identified as a consumer of interest to a merchant based on the consumer's transaction history at the merchant, types of transactions, type of transaction account, frequency of transactions, number of transactions, lack of transactions, timing of transactions, transaction history at other merchants, demographic information, personal information (e.g., gender, race, religion), social media or any other online information, potential for transacting with the merchant and/or any other factors.

The phrases consumer, consumer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A “record of charge” or “ROC” may comprise a record of a transaction or charge by a consumer with a particular merchant. In various embodiments, a ROC may correspond to an individual transaction. Further, in various embodiments, a ROC may comprise a cumulative value, which may indicate a number of total transactions (e.g., purchases) a consumer has made with a particular merchant. Further still, in various embodiments, a ROC may simply comprise an indication that a consumer has conducted at least one transaction with a merchant (e.g., within a particular time period). For instance, where a consumer's transaction history shows that the consumer has made at least one purchase from a merchant (e.g., within 12 months), a ROC may simply comprise a binary value, such as a “1” or a “yes.” Conversely, where a consumer's transaction history indicates that a consumer has not made a purchase from a merchant, a ROC may simply comprise a value such as a “0” or a “no”. Various embodiments may be described with respect to purchases; however, the system contemplates any transaction in association with the system.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “user profile” or “consumer profile” or “consumer profile data” may comprise any information or data about a consumer that describes an attribute associated with the consumer (e.g., a preference, an interest, demographic information, personally identifying information, and/or the like). In various embodiments, a consumer profile may be based upon a variety of data. For example, a consumer profile may be based upon data that is received, culled, collected, and/or derived from a variety of sources, such as a consumer's transaction history, data associated with or available via a consumer's social networking profile (e.g., a consumer's FACEBOOK profile), data associated with a consumer's physical location, and/or other publicly and/or privately available sources of information about a consumer. In various embodiments, a consumer profile may not be based upon such data, unless a consumer opts in or requests that such data be used.

Further, in various embodiments, a consumer profile may be based upon data contributed by a consumer, a merchant, a third party, and/or an SE (as described herein). Such data may comprise, for example, a consumer's personal information, e.g., demographic information, a consumer's date of birth, a consumer's residence information, an address of the consumer's work, a specific preference associated with the consumer (e.g., a preference for a certain type of vacation, such as a preference for a tropical vacation), a website in which the consumer is interested, and/or the like. Further, a consumer may contribute data towards a consumer profile by way of a form and/or questionnaire, such as, for example, a web-based form or questionnaire.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® OS, UNIX® OS, LINUX® OS, MacOS, etc.) as well as various conventional support software and drivers typically associated with computers.

The various system components may be independently, separately or collectively suitably coupled to the network via data links which includes, for example, a connection to an Internet Service Provider (ISP) over the local loop as is typically used in connection with standard modem communication, cable modem, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

With further regard to the types of data which may be contributed to a consumer profile, in general, any information that a consumer would like to serve as a basis for a consumer profile may be contributed. For instance, a consumer profile may comprise location data (e.g., data associated with a global positioning system, a home address, a work address, family location data, data about a consumer's most shopped or favorite shopping locations, data about a consumer's most visited or favorite places), data associated with a consumer's favorite websites, digital destinations, or magazines (e.g., blogs, news websites, shopping websites, research websites, financial websites, etc.), personal data (e.g., email addresses, physical addresses, phone numbers, age information, income information, expenses information, etc.), data associated with a consumer's status or mode of travel (e.g., vacation data, business data, personal data, airline data, lodging data, etc.), data associated with a consumer's favorite items (e.g., food, restaurants, groceries, electronics, music, gaming, clothing types, hobbies, fitness, etc.), and/or the like.

In addition, in various embodiments, a consumer profile may include online tracking cookie data, web beacon data, web tracking data, web packet trace data, digital fingerprint data, clickstream data, purchase or transaction history data, data entered by a consumer in a web based form, data purchased by a merchant about a consumer, social networking data, banking and/or credit card data, stock keeping unit (“SKU”) data, transactional and/or budget data, coupon data, retail data (e.g., items purchased, wish lists, etc.), data from third party personal data aggregators, search engine data, and/or any other data which the merchant may have in its possession or to which the merchant may gain access.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

In various embodiments, a consumer may specify that a consumer profile may be based upon certain data, but that the profile should not be based upon other data. For example, a consumer may specify that the consumer's profile may be based upon data associated with the consumer's transaction history, but may not be based upon data culled from the consumer's social networking profile.

Phrases and terms similar to an “entity” may include any individual, consumer, consumer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account,” “transaction account,” “account,” “account number,” “account code,” and/or “consumer account” may include any account that may be used to facilitate a transaction (e.g., financial transaction). These accounts may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card and/or an associated account.

Further, the phrase “size of wallet” may refer to a consumer's or business' total aggregate spending. Likewise, as used herein, the phrase “share of wallet” may represent how a consumer uses different payment instruments. A size of wallet and a share of wallet may, for example, be determined as described in U.S. patent application Ser. No. 10/978,298 filed, Oct. 29, 2004, and entitled Method and Apparatus for Estimating the Spend Capacity of Consumers, which is incorporated herein by reference in its entirety for all purposes.

The terms “computer program medium” and “computer usable medium” and “computer readable medium” are used to generally refer to media such as removable storage drive and a hard disk installed in hard disk drive. These computer program products provide software to computer system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, UNIX® OS, LINUX® OS, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In general, although embodiments are described with additional detail herein, an item may be tailored to a consumer based upon a collaborative filtering algorithm. In various embodiments, a collaborative filtering algorithm may identify items that are relevant to one or more consumers. For example, a collaborative filtering algorithm may assign a score to one or more items, where the score may be based on information such as a consumer profile, a transaction history associated with a consumer, social data (e.g., data associated with a social media channel, such as FOURSQUARE, FACEBOOK, TWITTER, and/or the like), demographic data, clickstream data, consumer feedback data, and/or the like. Thus, a score may identify relevant items based upon a variety of information associated with a consumer.

Moreover, in various embodiments, an item may be tailored to a consumer based on a merchant's needs (e.g., that the merchant is interested in rewarding existing loyal consumers and/or that the merchant would like to acquire new consumers). Further still, in various embodiments, an item may be tailored to a particular consumer based upon a business rule, such as, for example, that it is a holiday, that it is a particular time of day, that the consumer is traveling, that the item is associated with a merchant who is some distance away and/or near to from the consumer's location, that the consumer has indicated a preference not to receive the item (e.g., the consumer has given the item a “thumbs down”), and/or the like.

In operation, social data may be used to determine how an item is displayed to a consumer or to modify a predetermined ranking. For example, an offer presented through FACEBOOK may comprise or be associated with criteria (e.g., keywords, metadata, and/or the like). Social data from FACEBOOK may be captured and compared to the criteria. Where there is a match or association between the criteria and the social data, the offer may be ranked higher, associated with a higher rank (e.g., higher number) or displayed more prominently based on the match or association. Business rules may be employed to define how a match or association is determined. The business rules may include that the social data partially match or associate with the criteria. The business rules may include that the social data exactly match or associate with the criteria. An exact match or association may be used to adjust the ranking of an offer (where the offer was previously ranked based on other data associated with the consumer) to ensure that the social data adjusts the ranking in a manner that is relevant and desirable for the consumer.

For example, company A may have a FACEBOOK page that a consumer can “like.” Another party may also have a FACEBOOK page that is critical of company A that a consumer can “like.” If the consumer “likes” company A's FACEBOOK page, that social data may be used to promote or adjust the rankings of an offer from company A based on the direct match. However, if the consumer “likes” the FACEBOOK page that is critical of company A, the social data may be ignored with respect to the ranking of an offer from company A or may be used to lower the ranking of the offer from company A.

Rankings of offers may also be adjusted based on other types of social data such as consumer broadcasts. For example, a consumer using TWITTER may broadcast tweets comprising hashtags and/or any other identifiers or keywords. The hashtag, identifier, and/or keyword data may be captured (e.g., via an API interfacing with Twitter, or being on a Twitter distribution list) and used to adjust offers associated with the hashtag, identifier, and/or keyword. The hashtag, identifier, and/or keyword data may be compared to criteria associated with the offer. The hashtag, identifier, and/or keyword data may also be evaluated to identify a consumer's interests, hobbies, and/or preferences. This knowledge of the consumer may affect the ranking of particular offers associated with any interest, hobby, or preference (e.g., if an offer is relevant to a particular consumer, the ranking of the offer may be increased).

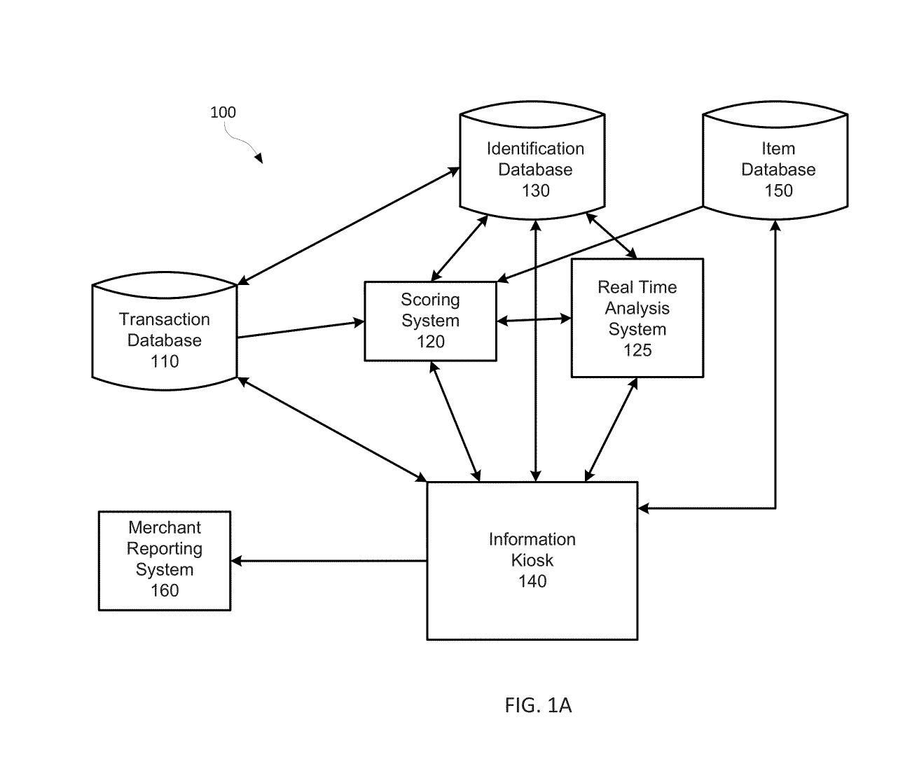

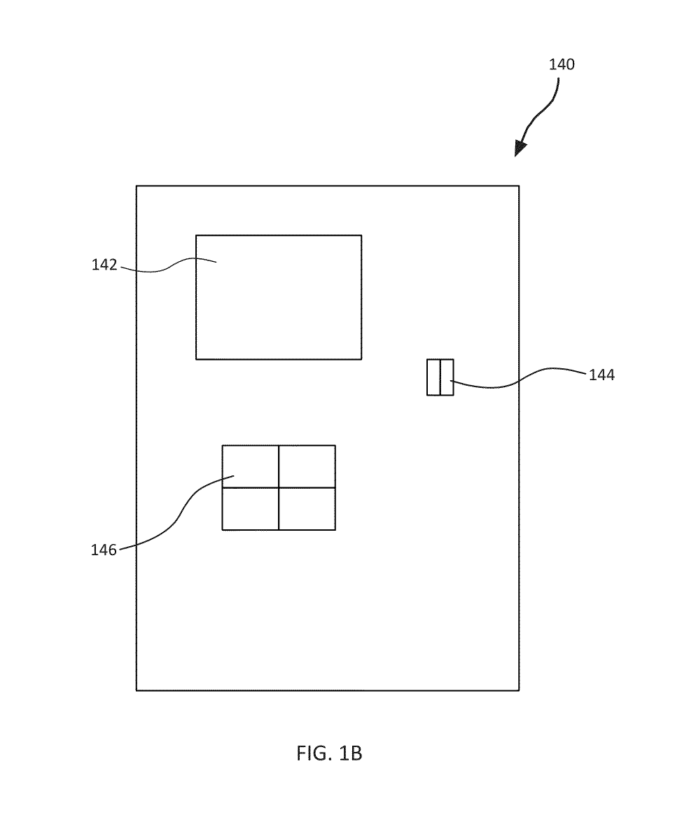

Accordingly, and with reference to FIG. 1A, an exemplary recommender system 100 for tailoring, recommending, and/or presenting (e.g., in real time) information (e.g., items such as merchant offers, merchants, restaurants, merchants or American Express promotions, etc.) to a consumer through an information kiosk is disclosed. In various embodiments, system 100 may comprise a transaction database 110, a scoring system 120, a real time analysis system 125, an identification database 130, an information kiosk 140, an item database 150, and/or a merchant reporting system 160.

Transaction database 110 may comprise hardware and/or software capable of storing data. For example, transaction database 110 may comprise a server appliance running a suitable server operating system (e.g., MICROSOFT INTERNET INFORMATION SERVICES or, “IIS”) and having database software (e.g., ORACLE) installed thereon. In various embodiments, transaction database 110 may store transaction history data associated with one or more consumers transacting with one or more merchants. Transaction history data may comprise a user's transaction data, including what transactions the user made, when they were made, where they were made, and/or the like.

Item database 150 may comprise hardware and/or software capable of storing data. For example, item database 150 may comprise a server appliance running a suitable server operating system (e.g., MICROSOFT INTERNET INFORMATION SERVICES or, “IIS”) and having database software (e.g., ORACLE) installed thereon. In various embodiments, item database 150 may store one or more items, such as one or more merchant offers, associated, for example, with one or more merchants, one or more recommendations, one or more coupons or rewards, and/or the like. Item database 150 may also store information associated with one or more items, such as information associated with one or more offers, one or more merchants, one or more recommendations, and/or the like.

Scoring system 120 may comprise hardware and/or software capable of scoring an item. In various embodiments, scoring system 120 may be in electronic communication with transaction database 110 and/or item database 150. In various embodiments, scoring system 120, comprising and implementing a collaborative scoring algorithm, may analyze a variety of transaction history data received from transaction database 110, and/or may use the analysis of the transaction history data to determine a score for an item received from item database 150, such as an offer and/or a merchant. Scoring system 120 may receive inputs including transaction history data associated with a consumer or user, a demographic of the consumer, a user profile, a type of transaction account, a transaction account associated with the consumer, a period of time that the consumer has held a transaction account, a size of wallet, a share of wallet, consumer feedback, information associated with an item usage, and/or information associated with a product usage. Scoring system 120 may look for a user's transaction habits or trends, such as the types of transactions, the types of products or services transacted for, the locations of transactions, the times of the day, week, month, and/or year the transactions are made, and/or the like, and match that information with items the consumer or user may be interested in.

The score of an item may be a consumer relevance value (or “CRV”), which is the relevance of a particular item to the consumer or user. Stated another way, the CRV is a score of how likely the consumer or user will be interested in the item and take advantage of the item being presented to them. Moreover, in various embodiments, scoring system 120 may comprise a variety of “closed loop” or internal data associated with a consumer. In various embodiments, scoring system 120 may comprise a system for tailoring marketing.

Real time analysis system 125 may comprise hardware and/or software capable of adjusting the relevance of an item (e.g., a scored offer and/or merchant) based upon a variety of criteria, such as one or more merchant criteria, one or more business rules, and/or the like. Real time analysis system 125 may be in electronic communication with, and receive the variety of criteria from, scoring system 120. Real time analysis system 125 may also be in electronic communication with, and receive information from, transaction database 110 through scoring system 120. For example, as described herein, real time analysis system 125 may monitor real time information associated with a consumer or user and/or merchant such as changes in merchant interest in acquiring new consumers, merchant interest in rewarding loyal consumers, time of year (i.e., holidays), time of day, consumer location, consumer preferences (e.g., the consumer has given the offer a “thumbs down,” or the consumer's transaction history data indicated a change in preferences), the consumers recent transaction history data, and/or the like. Based on any such changes, real time analysis system 125 may adjust the CRVs for consumers and items of potential interest to those consumers. In various embodiments, real time analysis system 125 may comprise a system, such as a system described in U.S. patent application Ser. No. 13/794,374, filed Mar. 11, 2013, and entitled Systems and Methods for Tailoring Marketing.

Identification database 130 may comprise hardware and/or software capable of storing data. For example, identification database 130 may comprise a server appliance running a suitable server operating system (e.g., MICROSOFT INTERNET INFORMATION SERVICES or, “IIS”) and having database software (e.g., ORACLE) installed thereon. In various embodiments, identification database 130 may store identifier information associated with one or more consumers transacting with one or more merchants. In various embodiments, the identifier information, such as a digital token, transaction history data, a transaction account, a user device, and/or the like, may be provided by a user profile associated with each consumer. The user profile may comprise a digital token, a transaction account, transaction history data, CRVs, a user device, social media channels and associated accounts, and/or other identifier information specific to the user in the user profile.

In various embodiments, the identifier information may be presented by a consumer or user to information kiosk 140 to allow information kiosk 140 to identify the consumer engaging it. In various embodiments, identification database 130 may be in electronic communication with, and retrieve information associated with the one or more consumers and their respective user profiles from transaction database 110, scoring system 120, and/or real time analysis system 125. In various embodiments, information kiosk 140 may be in communication with identification database 130, and may retrieve information from identification database 130 based on the identifier information presented by the consumer or user to information kiosk 140.

With reference to FIG. 1B, information kiosk 140 may be a point of interaction device which incorporates hardware and/or software components. In various embodiments, information kiosk 140 may comprise a processor, a tangible non-transitory computer-readable memory, and/or a network interface. In various embodiments, instructions stored on the tangible non-transitory memory may allow information kiosk 140 to perform various functions, as described herein. Information kiosk 140 may be in electronic communication with transaction database 110, scoring system 120, real time analysis system 125, identification database 130, and/or item database 150, and information kiosk 140 may participate any or all of the functions performed by a transaction database 110, scoring system 120, real time analysis system 125, identification database 130, item database 150 via the processor.

The various system components may be independently and separately or collectively suitably coupled to information kiosk 140 via data links which include, for example, a connection to an Internet Service Provider (ISP) over the local loop as is typically used in connection with standard modem communication, cable modem, Dish networks, ISDN, Digital Subscriber Line (DSL), or various wireless communication methods. It is noted that information kiosk 140 may be implemented variously, such as, for example, as an interactive television (ITV) network. Moreover, this disclosure contemplates the use, sale or distribution of any items, goods, services or information over any network having similar functionality described herein.

In various embodiments, with reference to FIG. 1B, information kiosk 140 may be a network connected real time information portal. Information kiosk 140 may comprise (for interfacing with a consumer or user) a display 142, an identity reader 144, and/or an input 146. Display 142 may be in electronic communication with the processor and configured to present information to a user. Display 142 may also comprise an interactive touch screen interface that presents user selectable items. Identity reader 144 may be in electronic communication with the processor and configured to capture identifier information from a user. Identity reader 144 may be any suitable identify detection device. Identity reader 144 may be configured to receive identifier information from a consumer or user. Identity reader 144 may be configured to identify and authenticate, through communication with the identification database 130, the identity of the consumer engaging an information kiosk 140. For example, identity reader 144 may be a payment reader, such as a card reader, a near field communication device, a biometric scanner (such as a fingerprint scanner and/or a facial recognition device), and/or any other device to establish the identity of the consumer engaging information kiosk 140. Identity reader 144 may be configured to capture identifier information (e.g., a transaction account number, a biometric input, a digital token, and/or the like). A payment reader may be a device that reads a payment device such as a card reader. Input 146 may be a user selectable input. Input 146 may be a touch sensitive interface, a key board, and/or may be integral to display 142.

A merchant reporting system 160 may comprise any hardware and/or software capable of generating a report and/or providing a report to a merchant. For example, in various embodiments, a merchant reporting system 160 may generate a report illustrating a ROI received by the merchant as the result of a tailored marketing campaign.

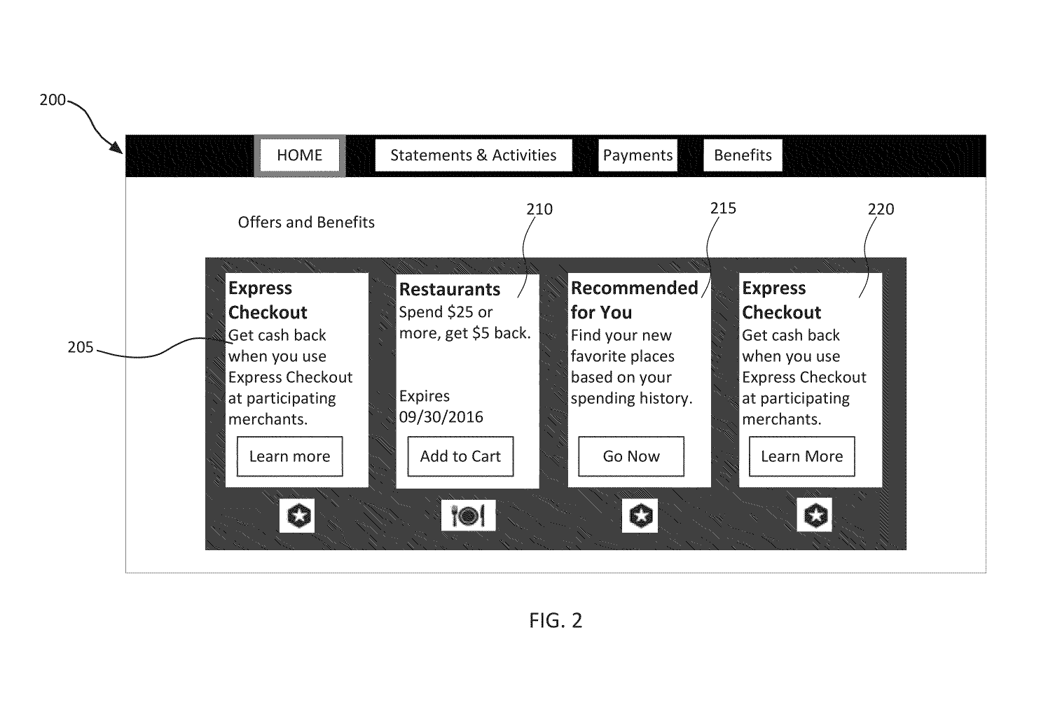

In operation, a consumer or user may present identifier information to identity reader 144 of an information kiosk 140. In various embodiments, information kiosk 140 may receive the identifier information. Information kiosk 140 may identify and authenticate a user profile associated with the identifier information provided by the consumer or user. In this regard, information kiosk 140 may access and/or retrieve the user profile from identification database 130. A CRV for one or more merchant offers may be established and updated in real time through the information kiosk 140 in conjunction with the transaction database 110, the scoring system 120, and/or real time analysis system 125. Information kiosk 140 may retrieve one or more merchant offer (or other item such as merchants, restaurants, promotions, recommendations) from the item database 150 based on the CRV associated with the user profile. One or more of those merchant offers that have high CRVs associated with the user profile may be retrieved. The merchant offer or offers retrieved by the information kiosk 140 may be transmitted by the information kiosk 140 to a display 142, such as a screen or user interface. The transmission may take the form of a ranked list including comprising the highest range of CRVs associated with the user profile, or any other suitable form to present to the consumer or user. Examples of transmissions of items on display 142 are shown in FIGS. 2-5. Moreover, additional information about CRVs and the associated offers may be found at U.S. patent application Ser. No. 13/794,374 filed on Mar. 11, 2013 and entitled “Systems and Methods for Tailoring Marketing”, which is incorporated by reference in its entirety.

FIG. 2 depicts an example of display 142 or user interface of the information kiosk 140 transmitting items, such as offers and benefits. As depicted in FIG. 2 on screen 200, offers and benefits may include checkout deals 205, restaurant options 210, recommendations 215, and/or affiliate items 220. All such items may be based off of the user's transaction history data and/or items with high CRVs.

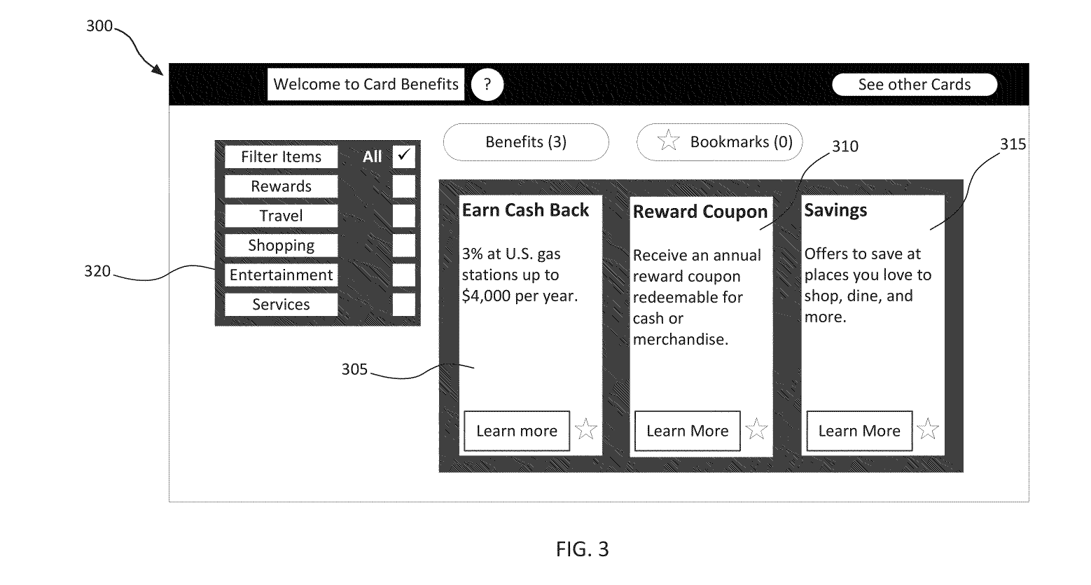

FIG. 3 depicts an example of display 142 or user interface of the information kiosk 140 transmitting items, and specific to FIG. 3, benefits. As depicted in FIG. 3 on screen 300, benefits may include cash back rewards 305, reward coupons 310, and/or savings offers 315. All such items may be based off of the user's transaction history data and/or items with high CRVs. In various embodiments, a menu 320 on display 142 may offer the consumer or user to select a category of items to view and select areas of interest.

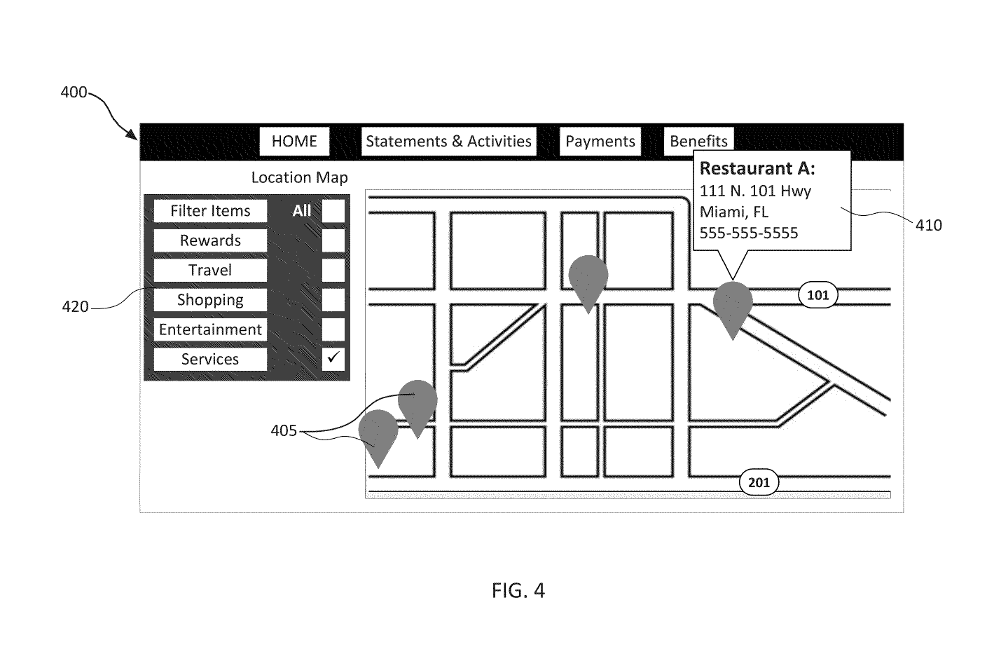

FIG. 4 depicts an example of display 142 or user interface of the information kiosk 140 transmitting items based on location, in accordance with various embodiments. As depicted in FIG. 4, the display 142 may show the locations of potential items of interest 405 to a consumer or user based on CRVs. Items of interest 405 (items with high CRVs) may be restaurants, as depicted in FIG. 4, and the consumer or user may be able to view different items of interest based on a menu 420. An information box 410 may be presented on display 142 in response to a consumer or user showing interest in one of the items of interest 405, for example, by clicking on an item of interest 405.

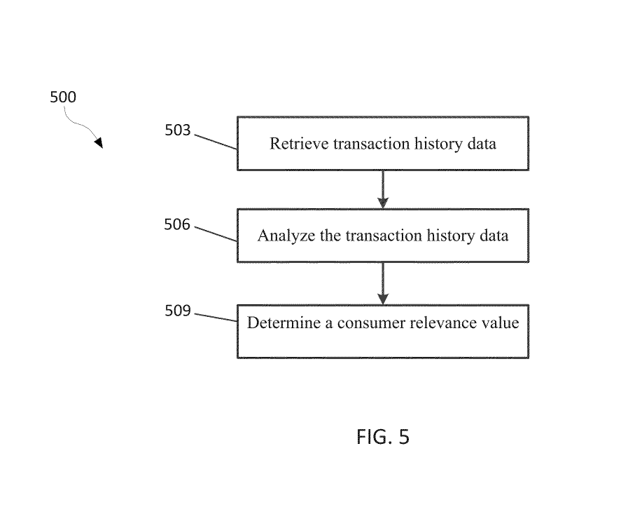

With reference to FIG. 5, the systems, modules, and kiosks described herein may be configured to perform a method 500 for scoring merchant offers. In various embodiments, each of the steps 503-509 may be performed alone and/or in combination with any other step 503-509. Accordingly, in various embodiments, transaction history data may be retrieved (step 503). Information kiosk 140 may retrieve the transaction history data that is associated with a user profile from transaction database 110. Information kiosk 140 may comprise a processor, a tangible non-transitory memory, a network interface, display 142, and/or identity reader 144. Information kiosk 140 may analyze the transaction history data (step 506) through electronic communication with scoring system 120 which comprises a collaborative scoring algorithm. Based on the analysis of the transaction history data by information kiosk 140 and scoring system 120, information kiosk 140 may determine a CRV (step 509) for at least one item (such as a merchant offer). The CRV may be reflective of the relevance of one merchant offer, or a plurality or list of merchant offers to a user profile.

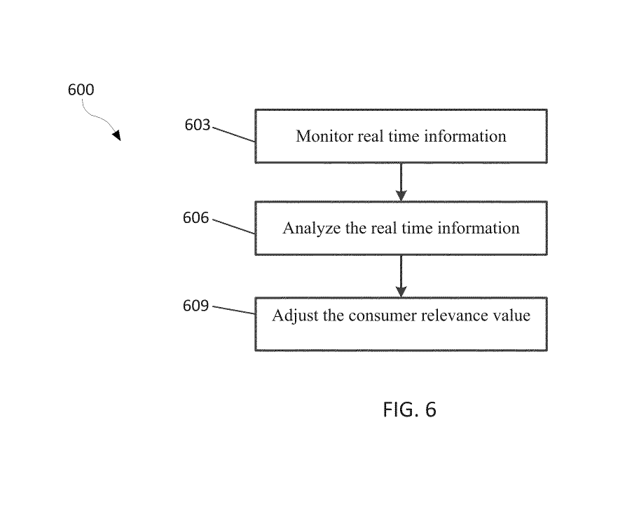

Referring to FIG. 6, a method for adjusting a CRV determined by information kiosk 140 and scoring system 120 is described (method 600). In various embodiments, each of the steps 603-609 may be performed alone and/or in combination with any other step 603-609. Accordingly, in various embodiments, information kiosk 140 and/or real time analysis system 125 may monitor real time information about the consumer or user (step 603). The real time information being monitored may be transaction history data that is being completed and accumulated by the consumer or user in real time. Information kiosk 140 and/or real time analysis system 125 may analyze the real time information received (step 606). The analysis may be looking at the real time information about the consumer, and determining if there are recent changes in transaction habits or trends, and/or the like. Information kiosk 140 and real time analysis system 125 and/or scoring system 120 may adjust the CRV that was determined earlier, in step 509 of FIG. 5 for instance, based on and in response to the analysis of the real time information gathered (step 609).

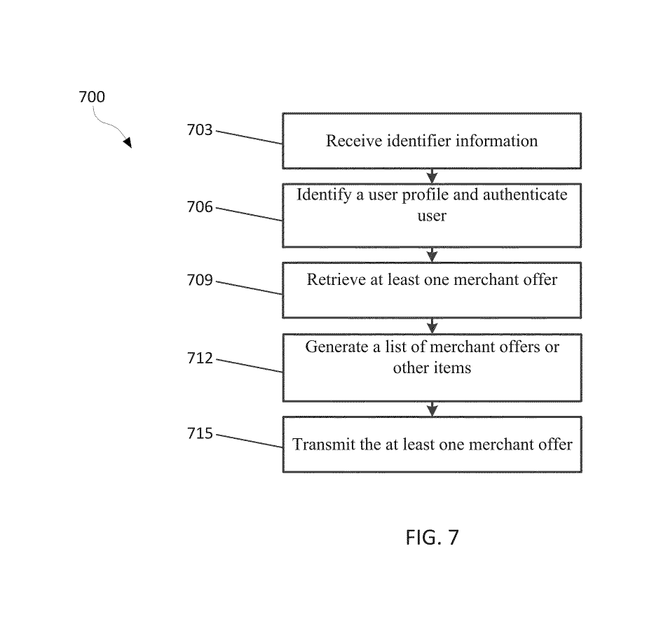

Referring to FIG. 7, a method for presenting a consumer or user with items, such as merchant offers, is described. In various embodiments, each of the steps 703-715 may be performed alone and/or in combination with any other step 703-715. Accordingly, as shown, in various embodiments, information kiosk 140 may receive identifier information from a user or consumer via identity reader 144 (step 703). A consumer or user may present his or her identifier information to identity reader 144. Information kiosk 140 may identify a user profile associated with the presented identifier information (step 706) by electronically communicating with identification database 130. Identification database 130 may store user-specific information, so the user profile in identification database 130 that has the same or most similar information provided by the consumer or user to information kiosk 140 may be the correct user profile. Information kiosk 140 may authenticate the identity of the consumer or user through identity reader 144 to make sure the consumer or user is the owner of the user profile that was identified (step 706). Based on the CRVs for different items (merchant offers, merchants, restaurants, promotions, etc.) associated with the user profile that was identified, information kiosk 140 may retrieve at least one item, such as a merchant offer, with a high CRV (step 709) from an item database 150. Information kiosk 140 may generate a list of the merchant offer or offers (or other items) retrieved by information kiosk 140 (step 712). The list may be ranked with the highest range of CRVs associated with the user profile, or any other suitable form to present to the consumer or user. In response to retrieving the at least one item (i.e., merchant offer), information kiosk 140 may transmit it on display 142 or other user interface (step 715). Such transmission may allow the consumer or user to view and interact with the item or other information that is being presented by information kiosk 140.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

In various embodiments, various components, modules, and/or engines of system 100 may be implemented as micro-applications or micro-apps. Micro-apps are typically deployed in the context of a mobile operating system, including for example, a Windows mobile operating system, an Android Operating System, Apple iOS, a Blackberry operating system and/or the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other sub sets.

As stated above, in various embodiments, the data can be stored without regard to a common format. However, in various embodiments, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and/or the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and/or the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and/or the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “consumer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

With further regard to terms such as “consumer,” “consumer,” “merchant,” and/or the like, each of these participants may be equipped with a computing device in order to interact with the system and facilitate online commerce transactions. A consumer or consumer may have a computing unit in the form of a personal computer, although other types of computing units may be used including laptops, notebooks, hand held computers, set-top boxes, cellular telephones, touch-tone telephones and/or the like. A merchant may have a computing unit implemented in the form of a computer-server, although other implementations are contemplated by the system. A bank may have a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

A merchant computer and/or a bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

An electronic commerce system may be implemented at the consumer and issuing bank. In an exemplary implementation, the electronic commerce system may be implemented as computer software modules loaded onto the consumer computer and the banking computing center. The merchant computer may not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and/or the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

The terms “payment vehicle,” “financial transaction instrument,” “transaction instrument” and/or the plural form of these terms may be used interchangeably throughout to refer to a financial instrument.

Phrases and terms similar to “internal data” or “closed loop data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the consumer and the merchant and also between merchant and payment processor.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the consumer and the merchant and also between merchant and payment processor.

What is claimed is:

1. A method, comprising:
retrieving, by an information kiosk and via a transaction database, transaction history data associated with a user profile;
wherein the information kiosk comprises a processor, a tangible non-transitory memory, a network interface, a display, and an identity reader;
analyzing, by the information kiosk and via a collaborative scoring algorithm of a scoring system, the transaction history data;
determining, by the information kiosk and via the scoring system, a consumer relevance value for a merchant offer based on the analyzing the transaction history data;
monitoring, by the information kiosk and via a real time analysis system, real time information about a consumer;
analyzing, by the information kiosk and via the real time analysis system, the real time information about the consumer;
adjusting, by the information kiosk and via at least one of the scoring system or the real time analysis system, the consumer relevance value based on and in response to the analyzing the real time information about the consumer.
receiving, by the information kiosk and via the identity reader, identifier information from the consumer;
identifying, by the information kiosk and via an identification database, a user profile associated with the identifier information;
retrieving, by the information kiosk, the merchant offer from an offer database based on the consumer relevance value associated with the user profile;
transmitting, by the information kiosk and via the display, the merchant offer onto the display in the information kiosk.

2. The method of claim 1, wherein the collaborative scoring algorithm receives as an input of at least one of: a transaction history data associated with a consumer, a demographic of the consumer, a user profile, a type of transaction account, a transaction account associated with the consumer, a period of time that the consumer has held a transaction account, a size of wallet, a share of wallet, consumer feedback, information associated with an item usage, or information associated with a product usage.

3. The method of claim 1, further comprising generating, by the information kiosk and based on a plurality of consumer relevance values, a ranked list of merchant offers comprising a highest range of consumer relevance values.

4. The method of claim 1, wherein the identifier information is at least one of a digital token, transaction history data, or a user device.

5. The method of claim 1, further comprising authenticating, by the information kiosk via the identity reader, the user presenting the identifier information to the information kiosk.

6. The method of claim 1, wherein the identity reader is at least one of a payment reader, a near field communication device, or a biometric scanner.

7. The method of claim 6, wherein the payment reader is a card reader.

8. An article of manufacture including a non-transitory, tangible computer readable memory having instructions stored thereon that, in response to execution by a processor in an information kiosk, cause the information kiosk to be capable of performing operations comprising:
retrieving, by the information kiosk and via a transaction database, transaction history data associated with a user profile;
analyzing, by the information kiosk and via a collaborative scoring algorithm comprised in a scoring system, the transaction history data;
determining, by the information kiosk and via the scoring system, a consumer relevance value for a merchant offer based on the analyzing the transaction history data;
monitoring, by the information kiosk and via a real time analysis system, real time information about a consumer;
analyzing, by the information kiosk and via the real time analysis system, the real time information about the consumer;
adjusting, by the information kiosk and via at least one of the scoring system or the real time analysis system, the consumer relevance value based on and in response to the analyzing the real time information about the consumer.
receiving, by the information kiosk and via an identity reader comprised therein, identifier information from the consumer;
identifying, by the information kiosk and via an identification database, a user profile associated with the identifier information;
retrieving, by the information kiosk, the merchant offer from an offer database based on the consumer relevance value associated with the user profile;
transmitting, by the information kiosk and via a display comprised therein, the merchant offer onto the display comprised in the information kiosk.

9. The article of claim 8, wherein the collaborative scoring algorithm receives as an input of at least one of: a transaction history data associated with a consumer, a demographic of the consumer, a user profile, a type of transaction account, a transaction account associated with the consumer, a period of time that the consumer has held a transaction account, a size of wallet, a share of wallet, consumer feedback, information associated with an item usage, or information associated with a product usage.

10. The article of claim 8, wherein the operations further comprise generating, by the information kiosk and based on a plurality of consumer relevance values, a ranked list of merchant offers comprising a highest range of consumer relevance values.

11. The article of claim 8, wherein the identifier information is at least one of a digital token, transaction history data, or a user device.

12. The article of claim 8, further comprising authenticating, by the information kiosk via the identity reader, the user presenting the identifier information to the information kiosk.

13. The article of claim 8, wherein the identity reader is at least one of a payment reader, a near field communication device, or a biometric scanner.

14. The article of claim 13, wherein the payment reader is a card reader.

15. An information kiosk, comprising;
a processor;
a display in electronic communication with the processor and configured to present information to a user;
an identity reader in electronic communication with the processor and configured to capture identifier information from a user; and
a tangible, non-transitory memory configured to communicate with the processor and having instructions stored thereon that, in response to execution by the processor, cause the information kiosk to be capable of performing operations comprising:
retrieving, by the information kiosk and via a transaction database, transaction history data associated with a user profile;
analyzing, by the information kiosk and via a collaborative scoring algorithm comprised in a scoring system, the transaction history data;
determining, by the information kiosk and via the scoring system, a consumer relevance value for a merchant offer based on the analyzing the transaction history data;
monitoring, by the information kiosk and via a real time analysis system, real time information about a consumer;
analyzing, by the information kiosk and via the real time analysis system, the real time information about the consumer;
adjusting, by the information kiosk and via at least one of the scoring system or the real time analysis system, the consumer relevance value based on and in response to the analyzing the real time information about the consumer.
receiving, by the information kiosk and via the identity reader, identifier information from the consumer;
identifying, by the information kiosk and via an identification database, a user profile associated with the identifier information;
retrieving, by the information kiosk, the merchant offer from an offer database based on the consumer relevance value associated with the user profile;
transmitting, by the information kiosk and via the display, the merchant offer onto the display comprised in the information kiosk.

16. The information kiosk of claim 15, wherein the collaborative scoring algorithm receives as an input of at least one of: a transaction history data associated with a consumer, a demographic of the consumer, a user profile, a type of transaction account, a transaction account associated with the consumer, a period of time that the consumer has held a transaction account, a size of wallet, a share of wallet, consumer feedback, information associated with an item usage, or information associated with a product usage.

17. The information kiosk of claim 15, wherein the operations further comprise generating, by the information kiosk and based on a plurality of consumer relevance values, a ranked list of merchant offers comprising a highest range of consumer relevance values.

18. The information kiosk of claim 15, wherein the identifier information is at least one of a digital token, transaction history data, or a user device.

19. The information kiosk of claim 15, further comprising authenticating, by the information kiosk via the identity reader, the user presenting the identifier information to the information kiosk.

20. The information kiosk of claim 15, wherein the identity reader is at least one of a payment reader, a near field communication device, or a biometric scanner.
